(19) United States
(12) Patent Application Publication
(10) Pub. No.: US 2007/0069407 A1
(43) Pub. Date: Mar. 29, 2007

(54) CARRIER DEVICE AND METHOD FOR MANUFACTURING OPTICAL DISK USING THE SAME

(75) Inventors: Li-Cheng Chen, Kaohsiung City (TW); Yu-Chi Hu, Taoyuan County (TW); Chien-Chung Chao, Taoyuan County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: DAXON TECHNOLOGY INC., Taoyuan County (TW)

(21) Appl. No.: 11/535,082

(22) Filed: Sep. 26, 2006

(30) Foreign Application Priority Data
Sep. 28, 2005 (TW) 94133789

(51) Int. Cl. B29D 17/00

(52) U.S. Cl. 264/1.33

(57) ABSTRACT

A carrier device used for carrying an optical disk in a manufacturing process is provided. The carrier device includes a base, a first supporting piece and a second supporting piece. The base includes a carrying area whose size is equal to that of the optical disk. The first supporting piece is protruded from the base and located at the center of the carrying area. The second supporting piece is disposed on the base and located in the carrying area. The second supporting piece is separated from the edge of the carrying area at a distance of more than or equal to one fourth of the radius of the carrying area.

This application claims the benefit of Taiwan application Serial No. 094133789, filed Sep. 28, 2005, the subject matter of which is incorporated herein by reference.

### BACKGROUND OF THE INVENTION

1. Field of the Invention

The invention relates to a carrier device for carrying an optical disk in a manufacturing process, and more particularly to a carrier device for carrying an optical disk during an ultraviolet curing process.

2. Description of the Related Art

When the optical disk is used in a high-speed data processing or recording, the mechanical characteristics thereof are requested more strictly. The mechanical characteristics, for example, the bending strength of the optical disk, the adhesion of two substrates, and the uniformity of the dye layer, would affect the properties of the optical disk while rotating.

In the DVD manufacturing process, a multi-layer film is sputtered on a substrate first, and then the substrate is adhered to another substrate via the ultraviolet curing process. The steps of the conventional ultraviolet curing process are disclosed below.

Firstly, a conventional ultraviolet curing tray is provided. Referring to FIG. 1A, a top view of a conventional ultraviolet curing tray is shown. The conventional tray 10 includes a base 7, a first supporting piece 8 and a second supporting piece 9. The base 7 includes a carrying area 7a. The carrying area 7a is a circular area whose diameter is 12 cm. The first supporting piece 8 is protruded from the center of the carrying area 7a. The second supporting piece 9 is disposed on the edge of the carrying area 7a. The base 7, the first supporting piece 8 and the second supporting piece 9 are integrally formed in one piece and are made from stainless steel.

Next, an ultraviolet curable adhesive is spread between two substrates of an optical disk. Because of the substrate design and the gravity effect, it is noted that the edge of the substrate would tilt downward slightly when the optical disk is put horizontally and merely supported at the center.

When the optical disk is placed on the conventional tray, the edge thereof would contact with the second supporting piece first, then the central hole thereof would be penetrated by the first supporting piece. Referring to FIG. 1B, a side view of the optical disk carried by the conventional ultraviolet curing tray of FIG. 1A is shown. When the optical disk 2 is carried by the first supporting piece 8 at a predetermined height h1, the second supporting piece 9 is also pressed upwardly to support the edge of the optical disk 2 at the same predetermined height h1. Lastly, an ultraviolet source is provided to cure the ultraviolet curable adhesive. The DVD manufacturing process is completed here.

However, the structure of the optical disk would deform easily and being instable if the edge part, the most instable structure of the optical disk, is pressed by the second supporting piece of the tray. Besides, the surface of the optical disk would be scratched because the second supporting piece is made from stainless steel. Moreover, a thermal effect caused by the high-temperature would make the optical disk deform while the optical disk contacts with the supporting piece directly. Thus the quality of the optical disk would become poorer.

### SUMMARY OF THE INVENTION

An object of the invention is to provide a carrier device and a method for manufacturing an optical disk using the same. The structure of the carrier device would be improved to reduce the damage occurred in the ultraviolet curing process for the optical disk. Therefore, the mechanical characteristics of the optical disk could be enhanced and the read/write quality of the optical disk could further be promoted.

According to the main object of the invention, a carrier device used for carrying an optical disk in manufacturing process is provided. The carrier device includes a base, a first supporting piece and a second supporting piece. The base includes a carrying area whose size is equal to that of the optical disk. The first supporting piece is protruded from the base and located at the center of the carrying area. The second supporting piece is disposed on the base and located in the carrying area. The second supporting piece is separated from the edge of the carrying area at a distance of more than one fourth of the radius of the carrying area.

According to the second object of the invention, a method for manufacturing an optical disk is further provided. The manufacturing method includes the following steps of providing an ultraviolet curable adhesive between two substrates of an optical disk; placing the optical disk in a carrier device; and providing an ultraviolet source to cure the ultraviolet curable adhesive. The carrier device includes a base, a first supporting piece and a second supporting piece. The base includes a carrying area whose size is equal to that of two substrates. The first supporting piece is protruded from the base and located at the center of the carrying area. The second supporting piece, disposed on the base and located in the carrying area, is separated from the edge of the carrying area at a distance of more than one fourth of the radius of the carrying area.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a top view of a conventional ultraviolet curing tray;

FIG. 1B is a side view of a the conventional ultraviolet curing tray of FIG. 1A when carrying an optical disk;

FIG. 2A is a top view of a carrier device according to a preferred embodiment of the invention;

FIG. 2B is a cross-sectional view of the carrier device of FIG. 2A viewed along a cross-sectional line 2B-2B′ in an arrow direction;

FIG. 3A is an optical disk when a force is applied to the center of the optical disk to carry the optical disk;

FIG. 3B is a side view of the carrier device of FIG. 3A when carrying an optical disk;

FIG. 4 illustrates the relationship of the disposition of the second supporting piece of the carrier device vs. the deflection and the axial acceleration of the optical disk according to a preferred embodiment of the invention.

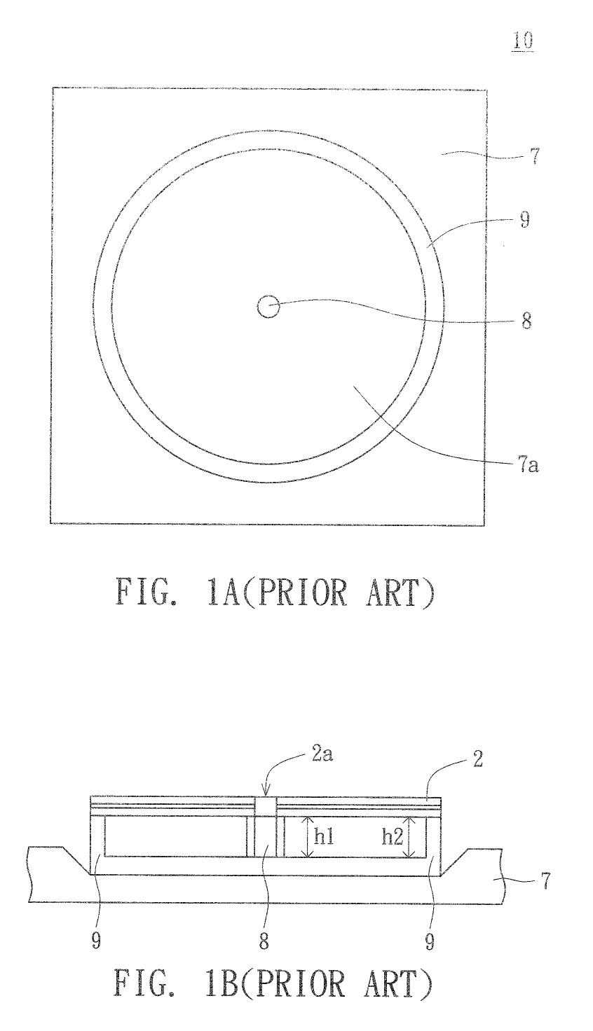

### DETAILED DESCRIPTION OF THE INVENTION

The main concept of the invention is to dispose the second supporting piece of the carrier device in the carrying area instead of disposing at the edge thereof, and to reduce the height of the second supporting piece for fitting the structure of the optical disk. Thus, the damage generated during the manufacturing process for the optical disk would be reduced and the mechanical characteristics of the optical disk would be enhanced. A preferred embodiment is exemplified below. However, the preferred embodiment is merely an embodiment according to the spirit of the invention, and the scope of protection of the invention is not limited thereto.

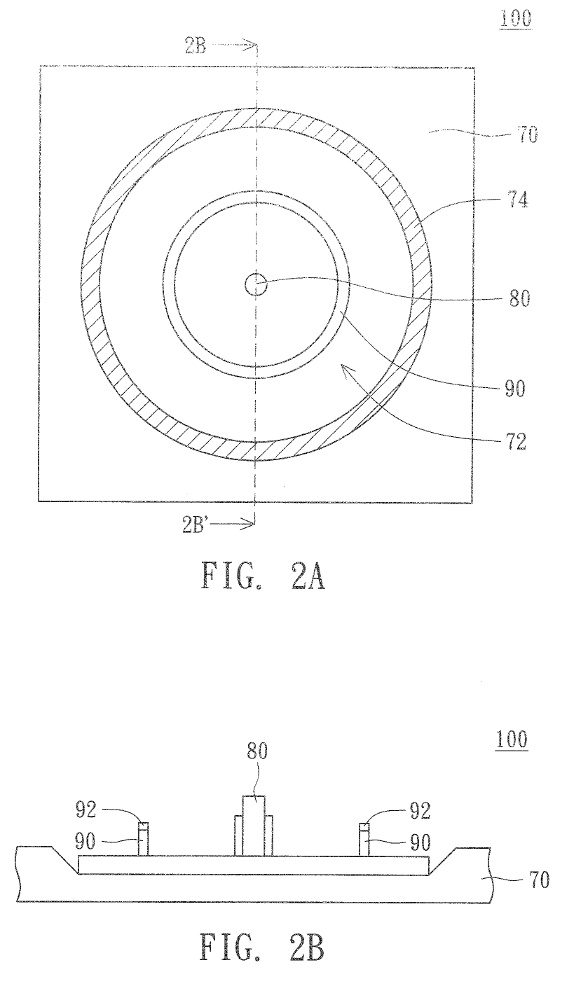

Referring to FIG. 2A, a top view of a carrier device according to a preferred embodiment of the invention is shown. The carrier device 100 of the present embodiment of the invention includes a base 70, a first supporting piece 80 and a second supporting piece 90. The base 70 includes a carrying area 72 whose size is substantially equal to that of the optical disk. The carrying area 72 could be a circular area whose radius is 60 mm. The first supporting piece 80 is protruded from the base 70 and located at the center of the carrying area 72. The first supporting piece 80 could be a column located at the center of the carrying area. The second supporting piece 90 is disposed on the base 70 and located in the carrying area 72. The second supporting piece 90 is separated from the edge of the carrying area 72 at a distance of substantially more than or equal to one fourth of the radius of the carrying area.

The base 70 further includes a low refraction area 74 which is substantially adjacent to the carrying area 72. For example, the low refraction area 74 is black.

Preferably, the second supporting piece 90 and the base 70 are integrally formed in one piece. Preferably, the second supporting piece 90 is a circular flange centered at the first supporting piece 80 and disposed on the base 70. For example, the base 70 is a tray made from stainless steel the first supporting piece 80 is a column made from stainless steel and integrally formed in one piece with the base 70, and the second supporting piece 90 is a circular flange made from stainless steel and integrally formed in one piece with the base 70.

Referring to FIG. 2B, a cross-sectional view illustrating the carrier device of FIG. 2A taken along the line 2B-2B′ and viewed along the direction indicated by an arrow is shown. The upper surface 92 of the second supporting piece 90 further includes a heat-resistant material having a low friction coefficient. The heat-resistant material for example, could be a Teflon.

The carrier device of the present embodiment of the invention is used for carrying an optical disk in the manufacturing process. Preferably, the carrier device of the present embodiment of the invention is applied in a digital versatile disc (DVD) manufacturing process. In the DVD manufacturing process, a metal film is sputtered on a substrate, and then the substrate is adhered to another substrate via the ultraviolet curing process. The steps of the ultraviolet curing process using the carrier device of the present embodiment of the invention are disclosed below.

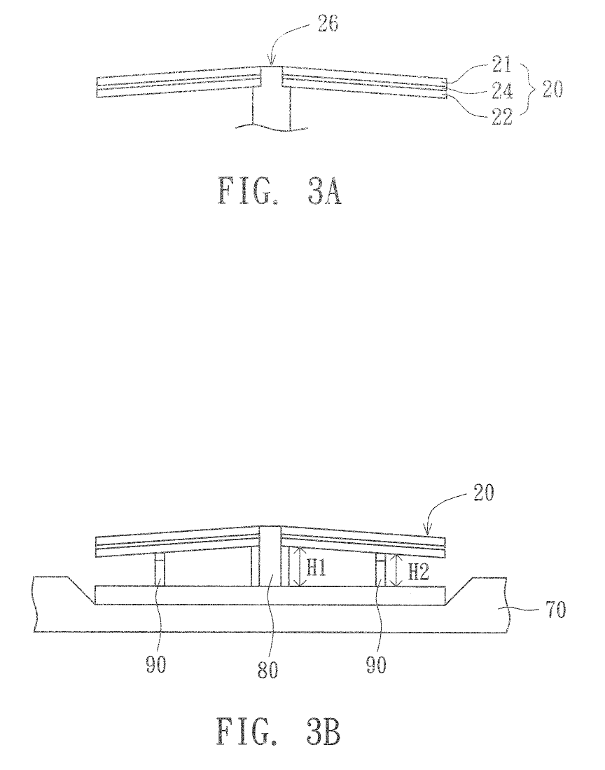

FIG. 3A shows a force is applied to the center of the optical disk for carrying the optical disk. Firstly, an ultraviolet curable adhesive 24 is provided between two substrates 21 and 22 of an optical disk 20. For example, the ultraviolet curable adhesive 24 is spreaded on the surface of the substrate 22 uniformly via spin coating, and then another substrate 21 is stacked on the substrate 21 to form the optical disk 20. There is a through hole 26 forming at the center of the optical disk 20. Because of the substrate design and the gravity effect, it is noteworthy that the optical disk 20 would be supported and the edge thereof would tilt downward slightly while applying a vertical force on the neighboring through hole 26.

Then, the optical disk is placed in a carrier device. Referring to FIG. 3B, a side view of an optical disk carried by the carrier device of FIG. 3A is shown. The through hole 26 of the optical disk 20 is correspondingly engaged with the first supporting piece 80, such that the optical disk 20 could be supported by the first supporting piece 80 at a predetermined height H1. In a static situation, the edges of the two substrates would tilt downward slightly. Preferably, the height H2 of the second supporting piece 90 is less than the predetermined height H1, so as to support the optical disk 20. Preferably, the height of the second supporting piece 90 is approximately equal to 70%˜90% of the predetermined height. For example, if the predetermined height H1 is substantially equal to 1 mm, then the height H2 of the second supporting piece 90 would range between 0.7˜0.9 mm. If the height of the second supporting piece 90 is less than or equal 0.9 mm, the force of the optical disk applied on the second supporting piece 90 would not too large to press the optical disk 20. On the other hand, if the height of the second supporting piece 90 is larger than or equal to 0.7 mm, then the optical disk 20 could be supported by the second supporting piece 90 and would not be bent downward by the weight thereof before curing. Consequently, the optical disk 20 would not be bent into a large angle. Therefore, the optical disk 20 could not only be supported by the second supporting piece 90, but also not be pressed by the second supporting piece 90 in the ultraviolet curing process, thus the structural deformation and instability thereof would be reduced.

Besides, in the present step, the upper surface 92 of the second supporting piece 90 used to contact with the optical disk 20 is made from a heat-resistant material which has a low friction coefficient. Accordingly, because of the low friction coefficient property, the surface of the optical disk would not be scratched while contacting with the second supporting piece 90. Meanwhile, because of the heat-resistant property, the thermal effect would not be generated while the optical disk contacts with the supporting piece.

Lastly, an ultraviolet source is provided to cure the ultraviolet curable adhesive 24, thereby the DVD manufacturing process would be completed. Since the carrier device is exposed to the ultraviolet rays for a long term, the base 70 would be remained at a very high temperature. This negative thermal effect could be reduced while the upper surface 92 of the second supporting piece 90 contacts with the optical disk. The negative thermal effect of the optical disk could be reduced while the optical disk contacts with the upper surface 92, on which the heat-resistant material is disposed, of the second supporting piece 90. On the other hand, a low refraction area 74, which is disposed on the peripheral of the carrying area 72, could reduce the refraction of the ultraviolet rays, thus the temperature of the edge of the optical disk could be decreased. Therefore, the optical disk would not deform at a high temperature.

Several series of experimental results shown below represent the mechanical characteristics of the DVD which be manufactured according to the above method. In the present embodiment of the invention, the diameter of the DVD is 12 cm, and the specification of the carrier device is fitted therefor. For example, the carrying area is a circular area whose diameter is 12 cm, and the first supporting piece is located at the center of the carrying area and is separated from the edge of the carrying area at a distance of a radius 6 cm, that is, 60 mm.

### FIRST EXPERIMENT

### The Axial Acceleration

Axial acceleration is the variation of axial velocity required for compensating the vertical variation of the optical disk when the optical pick-up head of the disk drive is tracking. The vertical variation of the optical disk is usually due to a micro-deformation and pits of a data layer. Within a specific limitation, the vertical variation of the optical disk still could be compensated by the tracking server of the disk drive via changing the read/write speed of the optical pick-up head. According to the DVD specification, the axial acceleration of the optical pick-up head could not exceed 15 m/s² while reading the DVD. If the vertical variation of the optical disk exceeds this limitation, the axial acceleration of the optical pick-up head would have to be increased correspondingly. Meanwhile, the laser light spot of the optical pick-up head could not be focused on the data layer, and thus the tracking performance of the optical pick-up head and the stability of the focusing server system would be affected. Accordingly, the axial acceleration is one of parameters for determining the quality of a DVD.

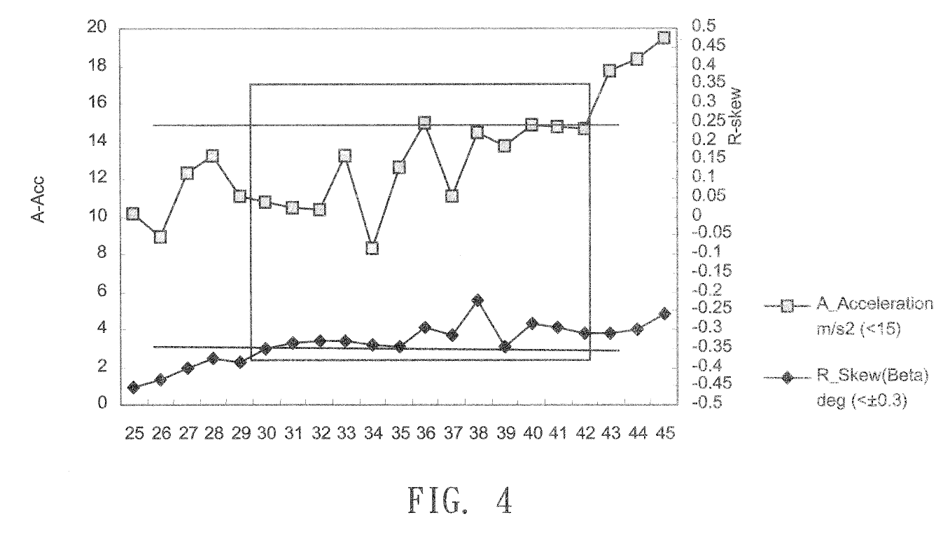

In the present experiment, the axial acceleration of the optical pick-up head is used for estimating the DVD quality which relates to the position of the second supporting piece 90, and thus the preferred position of the second supporting piece 90 would be obtained. In detail, every carrier device having different second supporting pieces, each of which is disposed at a varied distance from the first supporting piece 80, is utilized for manufacturing a DVD respectively. In order to estimate the qualities of those DVDs, the axial accelerations of the optical pick-up head required for tracking those DVDs correctly are measured respectively. By doing so, the preferred position of the second supporting piece 90, by which a DVD meeting the standard can therefore be manufactured, could be obtained. Referring to FIG. 4, the relationship of the disposition of the second supporting piece of the carrier device vs. the deflection and the axial acceleration of the optical disk according to a preferred embodiment of the invention is shown. The X-axis denotes the distance between the second supporting piece and the first supporting piece. The left Y-axis denotes the axial acceleration when the optical pick-up head reads the optical disk. As shown in FIG. 4, when the distance between the second supporting piece 90 and the first supporting piece 80 is shortened, the axial acceleration of the corresponding optical pick-up head would be diminished. As long as the distance between the second supporting piece and the first supporting piece is smaller than 42 mm, the axial acceleration is smaller than 15 m/s².

According to the results of the present experiment, the DVD manufactured by the carrier device 100 of the present embodiment, in which the carrying area 72 is a circular area having a diameter of 120 mm and the second supporting piece 90 is disposed within the distance of 42 mm from the first supporting piece, has excellent mechanical characteristics which complies with the standard of the optical disk specification. That is, the vertical deflection of the rotating DVD is so small that the axial acceleration of the optical pick-up head is smaller than 15 m/s² when tracking the DVD. Thus, the optical disk manufactured by the carrier device of the invention can be at least operated at eight times (8×) of tracking speed, so as to support that the optical disc driver reads or writes at this speed.

### SECOND EXPERIMENT

### The Radial-Skew Angle

When the optical disk rotates, the R-skew angle on the surface of the rotating optical disk is measured by the optical pick-up head. Within a tolerable range, the R-skew angle of the optical disk still could be compensated by the tracking server of the optical pick-up head via changing the read/write speed of the optical pick-up head. For example, it is set in the specification of the DVD that the R-skew angle must be within the range of ±0.3° when the DVD rotates at 8× of the tracking speed. However, if the R-skew angle exceeds the range of ±0.3°, the performance of the optical pick-up head in tracking and focusing will be deteriorated, and there will be problems in reading/writing data. Accordingly, the R-skew angle is also one of parameters for determining the quality of a DVD.

In the present experiment, the R-skew angle is used for estimating the DVD quality which relates to the position of the second supporting piece 90, and thus the preferred position of the second supporting piece 90 would be obtained. In detail, every carrier device having different second supporting pieces, each of which is disposed at a varied distance from the first supporting piece 80, is utilized for manufacturing a DVD respectively. In order to estimate the qualities of those DVDs, the R-skew angles of those rotating DVDs are measured respectively. By doing so, the preferred position of the second supporting piece 90, by which a DVD meeting the specifaction can therefore be made, is determined. Referring to FIG. 4, the X-axis denotes the distance between the second supporting piece and the first supporting piece, and the right Y-axis denotes the R-skew angle of the rotating optical disk. As shown in FIG. 4, as long as the distance between the second supporting piece and the first supporting piece becomes larger than 30 mm, the R-skew angle of the rotating optical disk is larger than −0.3° and smaller than +0.3°, and within a tolerable range of the specification.

According to the results of the first and the second experiments, the optical disk manufactured by the carrier device of the present experiment, in which the carrying area 72 is a circular area whose radius is 60 mm and the second supporting piece 90 is disposed within the distance of 30 mm˜42 mm from the first supporting piece, has excellent mechanical characteristics. Both of two parameters, axial acceleration and R-skew angle, of the qualities of the optical disk are complied with the specification standard of the optical disk. That is, the DVD manufactured by using the above carrier device has a flatter structure and has a smaller vertical deflection when the DVD rotates. The axial acceleration of the optical pick-up head is smaller than 15 m/s² and the R-skew angle of rotating DVD is within the range of ±0.3° as shown in FIG. 4. Accordingly, the optical disk could be operated at 8× of the tracking speed for reading/writing data on the optica disk. Thus it can be seen that the second supporting piece 90 of the present embodiment of the invention is preferably separated from the first supporting piece 80 at a distance ranging from a half of the radius to three fourths of the radius.

As described hereinbefore, the carrier device and the method for manufacturing an optical disk using the same is disclosed in the above embodiment of the invention. The second supporting piece of the carrier device is disposed further inwardly to avoid being disposed at the edge of the carrying area. Thus, the optical disc is supported by the second supporting piece at a stable position in terms of the structure of the optical disk, such that the optical disk will not be pressed and deformed by the second supporting piece in the ultraviolet curing process. Furthermore, the height of the second supporting piece is reduced, such that the optical disk will not be pressed and deformed by the second supporting piece during the manufacturing process.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A carrier device used for carrying an optical disk in a manufacturing process, the carrier device comprising:
a base, comprising a carrying area whose size is equal to that of the optical disk;
a first supporting piece protruded from the base and located at the center of the carrying area; and
a second supporting piece disposed on the base and located in the carrying area, wherein the second supporting piece is separated from the edge of the carrying area at a distance of more than or equal to one fourth of a radius of the carrying area.

2. The carrier device according to claim 1, wherein the second supporting piece is separated from the first supporting piece at a distance ranging from a half of the radius to three fourths of the radius.

3. The carrier device according to claim 1, wherein a through hole located at the center of the optical disk is correspondingly engaged with the first supporting piece for carrying the optical disk at a predetermined height.

4. The carrier device according to claim 1, wherein the height of the second supporting piece is less than the predetermined height so as to support the optical disk.

5. The carrier device according to claim 1, wherein the height of the second supporting piece is approximately equal to 70%˜90% of the predetermined height.

6. The carrier device according to claim 1, wherein an upper surface of the second supporting piece is made of a heat-resistant material having a low friction coefficient.

7. The carrier device according to claim 6, wherein the heat-resistant material is Teflon.

8. The carrier device according to claim 1, wherein the second supporting piece is a circular flange which be centered at the first supporting piece and disposed on the base.

9. The carrier device according to claim 1, wherein the second supporting piece and the base are integrally formed in one piece.

10. The carrier device according to claim 1, wherein the base further comprises a low refraction area which is adjacent to the carrying area.

11. The carrier device according to claim 10, wherein the low refraction area is black.

12. A method for manufacturing an optical disk, comprising the steps of:
providing an ultraviolet curable adhesive between two substrates of the optical disk.
placing the optical disk in a carrier device, the carrier device comprising:
a base, comprising a carrying area whose size is equal to that of the two substrates;
a first supporting piece protruded from the base and located at the center of the carrying area; and
a second supporting piece disposed on the base and located in the carrying area, wherein the second supporting piece is separated from the edge of the carrying area at a distance of more than one fourth of a radius of the carrying area; and
providing an ultraviolet source to cure the ultraviolet curable adhesive.

13. The method according to claim 12, wherein the optical disk has a through hole at the center thereof, and the step of placing the optical disk in the carrier device further comprises:
enabling the through hole to be correspondingly engaged with the first supporting piece so as to support the optical disk at a predetermined height;
wherein the height of the second supporting piece is less than the predetermined height so as to support the optical disk.

14. The method according to claim 13, wherein the height of the second supporting piece is approximately equal to 70%˜90% of the predetermined height.

15. The method according to claim 12, wherein the second supporting piece is separated from the first supporting piece at a distance ranging from a half of the radius to three fourths of the radius.

16. The method according to claim 12, wherein an upper surface of the second supporting piece is made of a heat-resistant material having a low friction coefficient.

17. The method according to claim 16, wherein the heat-resistant material is Teflon.

18. The method according to claim 12, wherein the second supporting piece is a circular flange which be centered at the first supporting piece and disposed on the base.

19. The method according to claim 12, wherein the second supporting piece and the base are integrally formed in one piece.

20. The method according to claim 12, wherein the base further has a low refraction area which is adjacent to the carrying area.

21. The method according to claim 20, wherein the low refraction area is black.
